(19) United States
(12) Patent Application Publication
(10) Pub. No.: US 2024/0007304 A1
(43) Pub. Date: Jan. 4, 2024

(54) PROCESS FOR CERTIFYING AN AGGREGATED APPLICATION, NETWORK SYSTEM IMPLEMENTING THE PROCESS, SOFTWARE PRODUCT

(71) Applicant: Robert Bosch GmbH, Stuttgart (DE)

(72) Inventor: Mark den Hartog, VW Eindhoven (NL)

(21) Appl. No.: 18/253,990

(22) PCT Filed: Nov. 26, 2020
(86) PCT No.: PCT/EP2020/083455

§ 371 Date: May 23, 2023

(51) Int. Cl. H04L 9/32; H04L 9/00

(52) U.S. Cl. CPC H04L 9/3263; H04L 9/50

(57) ABSTRACT

With increasing complexity of computer programs, no single person or groups is able to build an application from scratch. In nearly all scenarios, new applications are built on-top of existing components/services, which are out-side of the control of the application developers. A process for certifying an aggregated application (4) is proposed, whereby the aggregated application (4) uses a plurality of constituents (5,6,7), whereby a group of the constituents (5,6,7) are own constituents (5,6) and another group of the constituents (5,6,7) are third-party constituents (5,7), whereby each constituents (5,6,7) comprises a constituent description (12,14,18,20), describing features of the constituent (5,6,7), whereby an aggregated application description certificate (9) is defined, —which directly certifies the constituent descriptions (12) of the own constituents (5,6) and which indirectly certifies constituent descriptions (14) of the own constituents (5,6) by nesting a description certificate (13) certifying the constituent descriptions (14) of the own constituents (5,6), so that all own constituents (5,6) are certified directly and/or indirectly; and—which indirectly certifies the constituent descriptions (18,20) of the third-party constituents by nesting a description certificate (15) certifying the constituent descriptions (18,20) of the third-party constituents (8).

### BACKGROUND

The invention discloses a process for certifying an aggregated application, a network system implementing the process and a respective software product.

With increasing complexity of computer programs, no single person or groups is able to build an application from scratch. In nearly all scenarios, new applications are built on-top of existing components/services, which are out-side of the control of the application developers.

Common examples such components are an operating systems, (statically or dynamically linked) third-party libraries, local service applications services, and remote network services. In turn, the applications themselves could also be used, knowingly or unknowingly, by other applications. The result is a large and complex web of interconnected components. These connections are generally very dynamic; they will evolve with new application versions, bug-fixes, new service providers. With the increasing processing power, increased storage and network connected devices (especially with IoT networks), the number of interdependencies has grown more than exponentially.

The document EP 0328232A2, probably representing the closest prior art, discloses a public key cryptographic system with enhanced digital signature certification, which authenticates the identity of the public keyholder. A hierarchy of nested certifications and signatures are employed which indicate the authority and responsibility levels of the individual whose signature is being certified.

### SUMMARY

A process for certifying an aggregated application, a network system implementing the process and a software product are disclosed.

Subject matter of the invention is a process for certifying an aggregated application. The aggregate application uses a plurality of constituents. The aggregated application is preferably defined as a network of constituents. The constituents can refer to hardware and/or software components. For example the constituents can refer to devices, actuators, sensors, operating systems, third-party libraries, third-party own application services, remote network services et cetera.

In this connection, the question of ownership, responsibility, accountability and certification arises. Ideally the end-customer would like an application developer/service provider to assume responsibility/accountability of the whole aggregated application. In practice up to now, the extent of accountability is limited explicitly by service agreements and software terms & conditions, usually only covering the applications and its direct dependencies. The remaining liability risks, for the application as a whole, may be partly mitigated further by demanding the application supplier to adhere to quality standards (certification declarations, clearance statements, etc.). The later does not, however, increase the accountability of the supplier in any way, but merely limits the (perceived) risk of non-quality. To make the dependencies more manageable, hierarchical sub-systems are defined/created, that group multiple components in one unit. When such a subsystem has a distinct legal owner, accountability becomes more manageable. This is one of the reasons why most companies prefer large, commercial, software suppliers. With the rise of Open Source Software, applications stores, web technology and different business model (e.g. Software/Platform/*** As A service′), the aggregated application can no longer be partitioned into clear, static, distinct subsystems, with clear legal ownership. Instead they are built on top of a mesh of loosely coupled, more or less independent components or ‘agents’. Defining ownership of the whole vertical stack, let alone taking any meaningful responsibility, becomes virtual impossible.

The following questions arising in this context:
1. How can an end-user be assured that the aggregate application will remain within specifications, during the whole application life cycle?
2. How can an application developer take responsibility of the integrity of the aggregate application, when most of the agents life cycles are outside her/his scope of influence?
3. How does an application developer monetarize the effort of integration, release and maintenance of an aggregate application, given the issues mentioned in bullet 2?
4. How can a certification agency or standardization body assist and/or assume (part of) the accountability (e.g. by proving an insurance policy)?
5. How can ownership and responsibility be managed in a continuously growing, large heterogeneous web consisting of loosely coupled, federated agents?

The constituents of the aggregated application can be divided in a group of own constituents and another group of third-party constituents. Software code or executable code from own constituents are provided by the developer. Such software code or executable code may be own or software code/executable code organised by the developer and provided to the aggregated application. Own constituents may be realised on one machine, like a computer, or maybe provided in a distributed network. Software code or executable code from third-party constituents are organised without responsibility of the developer. The software code or executable code is also called implementation.

Each constituents comprises a constituent description. The constituent description describes features, especially technical and/or semantical features, of the constituent. The content of the constituent description depends on the type of the constituent.

The certification process comprises the step of defining and generating an aggregated application description certificated, whereby the constitutions are certified as follows:

The aggregated application description certificate directly certifies the constituent descriptions of the own constituents.

The aggregated application description certificate indirectly certifies constituent descriptions of the own constituents by nesting a description certificated certifying the constituent descriptions of the own constituents. Such a constituent without dependencies on other constituents, it is directly certified by the constituent owner, creating a constituent description certificate. This type can used for interface descriptions, specifications and/or standards. This type of certification is used by software code or executable code, which is not produced by the developer, but is implemented by the developer. The nested description certificate may be a third-party certificate, which is coupled with the software code or executable code, which is implemented in the aggregated application.

An aggregated constituent creates a constituent description certificate that includes its own constituent description and all the constituent description certificates of its dependent constituents. For example, an aggregated application description certificate, certifies its own application description and all its dependent constituent descriptions. The nested description certificates may be third-party certificates, coupled with the software code or executable code, which is used by the aggregated application during application implementation or during the application execution.

This aggregate application description itself is still code-free, since it only contains semantic, technical descriptions and dependent constituent description certificates. It can therefore be used independently of the actual application implementation. To certify the implementation itself, a different type of aggregate constituent description is created, the application instance certificate, that certifies an the software code or executable code, the aggregate application description and, optionally, the constituent description certificates any remaining dependencies that may result from additional implementation constraints. This part will be explained later.

As a result all own constituents of an aggregate application are certified directly and/or indirectly.

Furthermore the constituent descriptions of the third-party constituents are indirectly certified by nesting a description certificated certifying the constituent descriptions of the third-party constituents.

It may be underlined that the aggregated application description certificate is restricted to certify the constituent descriptions and not the software code or executable code of the constituents connected to the constituent descriptions. The aggregated application description certificate can thus be called software-free.

This invention disclosure proposes a cryptographic infrastructure to first certify each individual constituents of the aggregated application separately and subsequently certify larger aggregates. The certification infrastructure could be based on design concepts developed originally for public key infrastructures, but could also be implemented without a central authority by using distributed cryptographic algorithms/designs, like the ones used in block-chains.

A further advantage is that the aggregated application description certificate is update-friendly, because it does not certify the software code/executable code, but only the functional and/or semantical features of the constituents as defined by the respective descriptions.

In a possible realisation of the invention the own constituents comprise at least one service-agent, whereby the service-agent comprises a service-agent description as the constituent description. The service-agent may be a library, framework, application, or service with a clear, well defined functionality, behaviour, life cycle and semantics. The service-agent description may comprise the full description of the functional design and behaviour of the service of the service-agent, including the non-functional requirements, such as up-time, latency, transactional integrity, etc. For instance using a Domain specific language or orchestration frameworks.

The own constituents may comprise a service-interface, whereby the service-interface comprises a service-interface description as the constituent description. The service-interface description may comprise the technical and semantical definition (for example Apache Avro (technical), HL7 (both technical and semantical)), how to interact with the service-agent, including the communication protocol bindings, security constraints, versioning, interface discovery, etc. Alternatively or additionally the full technical and semantical specification of the service-interface, including all dependent information.

The own constituents may comprise a service adapter, whereby the service adapter comprises a service adapter description as the constituent description. This service adapter description may comprise a description how a specific external interface is used by the service-agent (e.g. subset of interface methods actually used, generated loads, communication protocol used, etc.).

As already discussed it is possible that the service-agent description and/or the service-interface description is/are certified directly. As an alternative it is possible that the service-agent description is certified by nesting a service-agent description certificate certifying the service-agent description and/or the service-interface description is certified by nesting a service-interface certificate certifying the service-interface description.

In a possible realisation the third-party constituents comprise at least one further aggregated application, whereby the further aggregated application comprises a further aggregated application description as the constituent description and whereby the further aggregated application description is certified by nesting the further aggregated application description certificate certifying the further aggregated application description. Within this realisation it is possible to add a plurality of third-party constituents to the own aggregated application by using our respective further aggregated application description certificate.

It is possible that the certificate based on a public key infrastructure design. Alternatively the certificate can also be implemented using non-hierarchical cryptograph algorithms, like the ones used in block-chains. The certification infrastructure could thus be based on design concepts developed originally for public key infrastructures, but could also be implemented without a central authority by using distributed cryptographic algorithms/designs, like the ones used in block-chains.

In a possible development of the invention, a validating tool validates that the aggregated application software comprising the own constituents, but without the third-party constituents, are complying with the own constituent descriptions. Thus the validating tool validates the implementation of the own constituents and their compliance with the certified constituent descriptions. Further the validating tool validates that the own constituents are complying with the description of the interaction with the third-party constituents as certified in the description certificate of the third-party constituents. In case the own constituents comply, a own aggregated application certificate is issued.

With the validating process it is checked whether or not the own constituents comprising own software code/executable code and third-party software code/executable code implemented into the aggregated application by the developer complies with the certified constituent descriptions. The said aggregated application certificate certifies that the software code/executable code, for which the developer is directly or indirectly responsible, complies with the descriptions as certified in the aggregated application description certificate.

Furthermore it is possible that the validating tool validates the further aggregated applications in the same manner in issues third-party aggregated application certificate. These third-party aggregated application certificate certify that the software code/executable code implemented in the third-party aggregated application comply with the descriptions as certified in the third-party aggregated application description certificate.

In a next step the own aggregated application certificate the third-party aggregated application certificate combined to an overall aggregated application certificate.

In case that for example a third-party aggregated application changes, the third-party aggregated application developer has to renew the respective third party aggregated application certificate. Then a new aggregated application certificate can be issued and the developer of the own aggregated application can trust or rely on it, that the own aggregated application will work in the same manner as before the changes the third-party aggregated application were made.

It is preferred that the validating tool is an additional aggregated application, which is certified as the aggregated application and is characterised in that the validating tool is validated by an additional validating tool, whereby the additional validating tool is based on a “root of trust” and/or a trust anchor. In said cryptographic system with hierarchical structure, the trust anchor is an authoritative entity for which trust is assumed and not derived.

A further subject matter of the invention is a network system implementing the process as described above. The network system comprises an aggregated application, the aggregated application uses a plurality of constituents, whereby the aggregated application comprises own constituents and is connected and/or connectable to third-party constituents forming a part of the network system.

Each constituents comprises a constituent description, describing features of the respective constituent.

The aggregated application comprises and/or is connected to an aggregated application description certificate, which directly certifies the constituent descriptions of the own constituents and which indirectly certifies constituent descriptions of the own constituents by nesting a description certificate certifying the constituent descriptions of the own constituents, so that all own constituents are certified directly and/or indirectly; and which indirectly certifies the constituent descriptions of the third-party constituents by nesting a description certificate certifying the constituent descriptions of the third-party constituents.

The network system is especially designed to implement the process as described before.

A further subject matter of the invention is a computer program implementing the process as described above, preferably in a network system as described above.

### BRIEF DESCRIPTION OF THE DRAWINGS

Further features, advantages and effects of the invention will become apparent by the description of preferred embodiment of the invention and the figures as attached. The figures show:

FIG. 1 a block diagram of a network system with an aggregated application;

FIG. 2 a block diagram of the network system in FIG. 1, whereby the aggregated application and constituents of the aggregated application are certified by a description certificate;

FIG. 3 a block diagram of the network system of the previous figures, whereby the aggregated application is validated by a validating tool.

### DETAILED DESCRIPTION

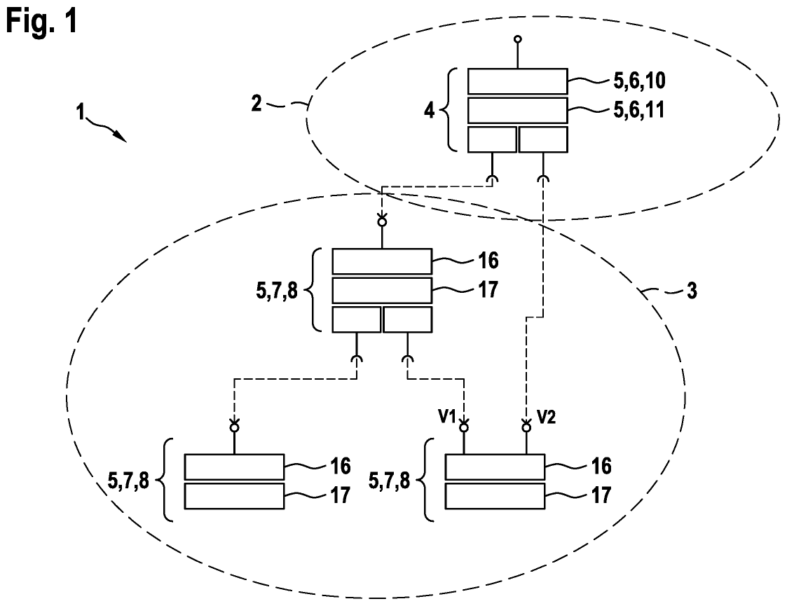

FIG. 1 shows in a block diagram a network system 1 as an embodiment of the invention. The network system 1 may be technically realised as part of a cloud 2 (or more clouds) and as part of distributed servers 3. The network system 1 comprises an aggregated application 4 whereby the aggregated application 4 uses a plurality of constituents 5. For the sake of clarity it is assumed that the aggregated application 4 is developed by a developer, whereby the aggregated application 4 will be called “own” aggregated application 4. The constituents 5 can be divided in own constituents 6 and third-party constituents 7. The own constituents 6 are implemented by our developer. In this connection the developer has the software code/executable code under his own control, at least concerning the integration of updates et cetera. The aggregated application 4 comprises the own constituents 6 and is connected, for example over a proxy by Internet, network et cetera, with a third-party constituent 7, which also forms a further aggregated application 8.

In the embodiment as shown in FIG. 1 the aggregated application 4 is realised as an application in the cloud 2, whereby the aggregated application 4 is a detection application. In this example, the end-users wants to use the cloud based service of the aggregated application 4 to identify faces in a video stream. The cloud service provider does not implement all require features, but uses a third party deep learning feature detector as a third-party constituent 7 in its face detection algorithm, which is shown in the middle of the FIG. 1. This DL feature detection service itself, uses a hardware accelerated DL platform, together they form one of the further aggregated applications 8 at the bottom on the left side. Both the face detection application and the DL feature detection service, use a micropayment provider service provider as third-party constituent 7 at the bottom on the right side, to monetize their services, which also forms one of the further aggregated applications 8. They do both, however, use different interface versions to the micropayment provider, since the DL feature detector was build/deployed well before the face detection service and still uses a legacy interface for micro payment provider service (v1).

The own aggregated application 4 comprises—as an example—a service-interface 10 and a service-agent 11 realised as a cloud application.

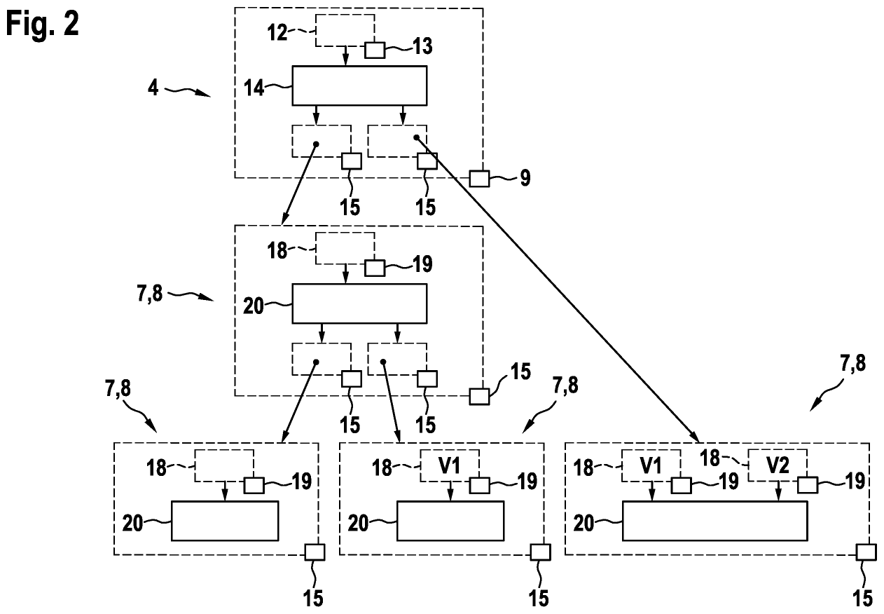

Starting from the block diagram of FIG. 1, FIG. 2 illustrates the definition and/or generation of an aggregated application description certificate 9 for the aggregated application 4. The blocks represent the same applications etc. as in FIG. 1.

The service-interface 10 has the function to interface between the service-agent 11 and a user. The service-interface 10 is coupled to a service-interface description 12 as a constituent description, whereby the service-interface description 12 comprises the technical and semantical definition how to interact with the service-agent 11 including the communication protocol bindings, security constraints, versioning, interface discovery et cetera. In this example the service-interface 10, especially the software code and/or executable code, provided by a third-party, whereby the third-party additionally provides the service-interface description 12 and a service-interface description certificate 13, which certifies the service-interface description 12.

The service-agent 11 provides the functionality and is coupled to a service-agent description 14. The further aggregated applications 8 each having a further aggregated application description certificate 15, which are description certificates for the third-party constituents 7 and which certifies constituent descriptions, especially further aggregated application descriptions, of the third-party constituents, especially further aggregated applications 8.

The service-interface description certificate 13 and the further service-interface description certificates 15 are nested into the aggregated application description certificate 9, whereby the aggregated application description certificate 9 additionally certifies the service-agent description 14.

The adjacent further aggregated application 8 provides the further aggregated application description certificate 15. The further aggregated application 8 comprises a further service-interface 16 and a further service-agent 17. The further service-agent 17 is provided by third-party, which also provide further service-interface description 18 and a further service-interface description certificate 19. The further service-agent 17 is connected to a further service-agent description 20. The further aggregated application description certificate 15 certifies the further service-agent description 20, additionally the further service-interface description certificate 19 and two further aggregated application description certificates 15 from the next two further aggregated applications 8 are nested into the further aggregated application description certificate 15.

The further aggregated applications 8 are comprising each further service-interface 16 and are further service-agent 17, each having a constituent description. The further service-interface 16 has a further service-interface description 18, which is certified by the third-party with a further service-interface description certificate 19. The further aggregated application description certificate 15 certifies the further service-interface description 18 indirectly by nesting the respective further service-interface description certificate 19 and by directly certifying the further service-agent description 20.

The further aggregated application 8 at the right side comprises two different further service-interfaces 16 V1/V2, whereby the further aggregated application description certificate 15 can be defined/generated whether by nesting both or all further service-interface description certificate 19 or by nesting only one of the further service-interface description certificate 19 depending on the purpose.

Summarised, the aggregated application description certificate 9 certificates directly the constituent descriptions of the own constituents 6 and indirectly certifies constituent descriptions of the own constituents 6 by nesting a description certificate certifying the constituent descriptions of the own constituents, so that all constituents descriptions are certified directly and/or and directly by the aggregated application description certificate 9.

Let's assume all interfaces used in this example are standardized and maintained by separate standardization bodies. For each interface version, the standardization body would issue an ‘interface certificate’ as the service-interface description certificate 13 or the further service-interface description certificate 19, which cryptographically protect the integrity of the communication semantics. Since the interface certificates 13, 19 are issued separately, they are not tied to a specific agent, nor is an agent restricted to implement only a single interface version.

As described, the functional/technical behaviour of the service-agent 11, 17 are described using ‘service description certificates’ integrated in the aggregated application description certificate 9, 15. In this example, DL framework provider service could issues a ‘DL framework service description certificate. This certificate would include a full description of the service as well as the certificates its dependencies. For aggregated service description, like the DL feature detector and the cloud application, it include their dependent the service description certificates. In this example the DL feature detection service includes one version of the payment service certificate (implementing only the v1 payment interface) and the face detection service description interface would include another service description certificate (implementing both v1 and v2).

The micropayment service provider would most likely publish its service description payment service to a wide audience, since the business model is based on transactions and not on the functional design of the service. This might not hold for the face detection service issuer, who might want to protect the functional design itself and publish its service description certificate to a smaller audience or limit access to the service description on a need-to-know based (e.g. accessible only for a regulatory body during certification). Using certificate hashes and standard asymmetric encryption, non-repudiation can be provided, by using trusted third parties, without revealing any classified or sensitive information.

Next an application developer can implement one or more service, by implemented an aggregated application 4, 8 that implements all required interfaces/services and adheres to all non-functional requirements. The aggregated application 4, 8 can subsequently be validated by using a provided (certified) validation tooling. The final agent certificate defined as an aggregated application certificate then be issued by company and/or an additional certification body.

Like the service description, the validation tooling does not have to be made public. The only requirement is that the root-of-trust ends with a trusted party, not that each individual step or description is made public.

After validation, the validator can issue ‘compliance certificate’, namely the aggregated application certificate, as proof that the agent implements all requirements associated with the interface description and service descriptions. Again, multiple compliance certificates/aggregated application certificates can be combined to an aggregate compliance certificate as an overall aggregated application certificate of all the constituents 5 that make the aggregate application 4, 8.

If the compliancy certificate/overall aggregated application certificate is combined with regular evaluation/monitoring of the running services, it could provide a real-time mechanism to chance the compliancy of (parts of) the aggregated application in real-time. The latter could signal end-user that the integrity of its service cannot be guaranteed, allowing for appropriate measure to be taken. This scheme can be seen as a ‘compliancy license’, and could be a unique revenue for a standardization body.

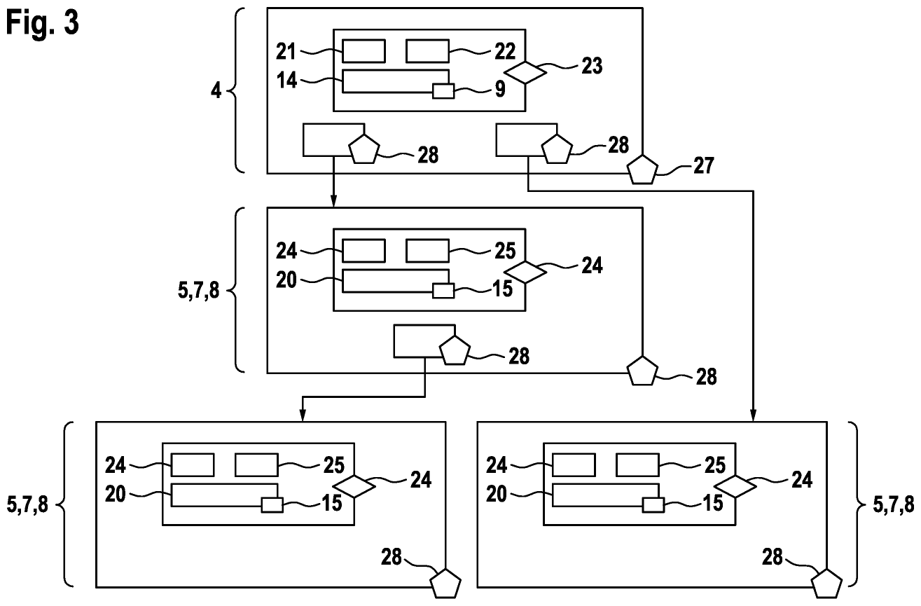

FIG. 3 illustrates the validating process. The aggregated application 4 is again the face detection application. The further aggregated application 8 in the middle of the figure is again the deep learning (DL) feature detector, the further aggregated application 8 on the left side at the bottom is again the hardware accelerated DL platform, which is used by the deep learning feature detector. The further aggregated application 8 the right side is the micro-payment service, which provides the two payment interface V1 and V2. The further aggregated application 8 in the middle of the last line in FIG. 2 is left out, because the aggregated application for does not use this aggregated application 8 is a third-party constituent.

During the validating process, a validating tool (not shown) validates in a first step, that the implementation 21 of the service-interface 10 and the implementation 22 of the service-agent 11 complies with the aggregated application description certificate 9 and issues an own aggregated application certificate 23.

In the same manner further aggregated application certificate 24 for the further implementation 25 of the further service interface 16 and further implementation 26 of the further service agent 17 is generated.

In a next step an overall aggregated application certificate 27 and further overall aggregated application certificate 28 are generated. As a general rule all aggregated applications, which form a constituents of the aggregated application to be validated are combined to our overall aggregated application certificate.

First the further aggregated applications 8, which have no further aggregated applications 8 as third-party constituents 7 are certified by the overall aggregated application certificate 28. These are the further aggregated applications 8 at the bottom line in FIG. 3. The further overall aggregated application certificate 28 comprises only the further aggregated application certificate 24 of the own aggregated application 8.

Next the further aggregated application 8 in the middle of FIG. 3 is certified by the further overall aggregated application certificate 28, whereby this further overall aggregated application certificate 28 comprises the further overall aggregated application certificate 28 from the aggregated application 8 on the left side at the bottom line and the further aggregated application certificate 24 of the own aggregated application 8.

1. A process for certifying &nil a computer-executable, aggregated application (4) in a computer network having multiple network constituents,
whereby the aggregated application (4) uses the plurality of network constituents (5,6,7),
whereby a group of the network constituents (5,6,7) is own constituents (5,6) and another group of the constituents (5,6,7) is third-party constituents (5,7),
whereby each network constituents (5,6,7) comprises a constituent description (12,14,18,20), describing features of the constituent (5,6,7),
whereby an aggregated application description certificate (9) is defined,
which directly certifies the constituent descriptions (12) of the own constituents (5,6) and which indirectly certifies constituent descriptions (14) of the own constituents (5,6) by nesting a description certificate (13) certifying the constituent descriptions (14) of the own constituents (5,6); and
which indirectly certifies the constituent descriptions (18,20) of the third-party constituents by nesting a description certificate (15) certifying the constituent descriptions (18,20) of the third-party constituents (8).

2. The process according to claim 1, wherein the own constituents comprise a service-agent (11), whereby the service-agent (11) comprises a service-agent description (14) as the constituent description and/or a service-interface (10), whereby the service-interface (10) comprises a service-interface description (12) as the constituent description.

3. The process according to claim 2, wherein the service-agent description (14) is certified by nesting a service-agent description certificate certifying the service-agent descriptions (14) and/or the service-interface description (12) is certified by nesting a service-interface description certificate (13) certifying the service-interface description (12).

4. The process according to claim 1, wherein the third-party constituents (7) comprise a further aggregated application (8), whereby the further aggregated application (8) comprises a further aggregated application description as the constituent description, whereby the further aggregated application description is certified by nesting a further aggregated application description certificate (15) certifying the aggregated application description.

5. The process according to claim 1, wherein the certificates (9,15) are based on a Public key infrastructure design.

6. The process according to claim 1, wherein the certificates (9,15) are based on a blockchain design.

7. The process according to claim 1, whereby a validating tool validates that the aggregated application implementation (21,22) and/or its own constituents (6) are complying with the own constituent descriptions including description of the interaction with the third-party constituents as certificated in the description certificate of the third-party constituents and issues an own aggregated application certificate (23).

8. The process according to claim 7, wherein the validating tool validates the further aggregated applications (8) in the same manner and issues third-party and/or further aggregated application certificates (24).

9. The process according to claim 7, wherein the own aggregated application certificate (23) and the third-party aggregated application certificates (24) are combined to an overall aggregated application certificate (27).

10. The process according to claim 7, wherein the validating tool is an additional aggregated application, which is certified as the aggregated application and in that the validating tool is validated by an additional validating tool, whereby the additional validating tool is based on “a root of trust”

11. A computer network system (1) comprising:
multiple network constituents; and
an aggregated application (4) configured to use the network constituents (5,6,7), whereby the aggregated application (4) comprises own constituents (5,6) and is connected and/or connectable to third-party constituents (5,7) forming a part of the network system (1), whereby each constituent (5,6,7) comprises a constituent description, describing features of the respective constituent (5,6,7), whereby the aggregated application (4) comprises and/or is connected to an aggregated application description certificate (9), which directly certifies the constituent descriptions of the own constituents (5,6) and which indirectly certifies constituent descriptions of the own constituents (5,6) by nesting a description certificate certifying the constituent descriptions of the own constituents (5,6); and which indirectly certifies the constituent descriptions of the third-party constituents (5,7) by nesting a description certificate certifying the constituent descriptions of the third-party constituents.

12. (canceled)

13. A non-transitory, computer-readable medium having instructions stored thereon that when executed by one or more computers cause the one or more computers to certify a computer-executable, aggregated application (4),
whereby the aggregated application (4) uses network constituents (5,6,7) of a computer network,
whereby a group of the network constituents (5,6,7) is own constituents (5,6) and another group of the constituents (5,6,7) is third-party constituents (5,7),
whereby each network constituent (5,6,7) comprises a constituent description (12,14,18,20), describing features of the constituent (5,6,7),
whereby an aggregated application description certificate (9) is defined,
which directly certifies the constituent descriptions (12) of the own constituents (5,6) and which indirectly certifies constituent descriptions (14) of the own constituents (5,6) by nesting a description certificate (13) certifying the constituent descriptions (14) of the own constituents (5,6); and
which indirectly certifies the constituent descriptions (18,20) of the third-party constituents by nesting a description certificate (15) certifying the constituent descriptions (18,20) of the third-party constituents (8).
